(19) United States
(12) Patent Application Publication
(10) Pub. No.: US 2024/0411979 A1
(43) Pub. Date: Dec. 12, 2024

(54) DETERMINING THE SIMILARITY OF TEXT PROCESSING TASKS

(71) Applicant: BEIJING BAIDU NETCOM SCIENCE TECHNOLOGY CO., LTD., BEIJING (CN)

(72) Inventors: Minlong PENG, BEIJING (CN); Mingming SUN, BEIJING (CN); Yabing SHI, BEIJING (CN)

(21) Appl. No.: 18/749,479

(22) Filed: Jun. 20, 2024

(30) Foreign Application Priority Data
May 28, 2024 (CN) 202410674677.7

(51) Int. Cl. G06F 40/10; G06N 3/08

(52) U.S. Cl. CPC G06F 40/10; G06N 3/08

(57) ABSTRACT

A method, apparatus, device, and medium for determining the similarity of text processing tasks is provided. The method includes: determining a first task, a second task, and a neural network, the neural network includes a plurality of network modules and a plurality of importance coefficients corresponding to the plurality of network modules, and the importance coefficients are used to scale output values of a corresponding network module; respectively performing a target operation using the first task and the second task as a target task to obtain an embedding feature of the first task and an embedding feature of the second task; and determining the task similarity between the first task and the second task based on the embedding features. The target operation includes: training using text samples and obtaining a plurality of trained importance coefficients; and determining an embedding feature of the target task based on trained importance coefficients.

### CROSS REFERENCE TO RELATED APPLICATION

This application claims priority to Chinese Patent Application No. 202410674677.7, filed on May 28, 2024, the contents of which are hereby incorporated by reference in their entirety for all purposes.

### TECHNICAL FIELD

The present disclosure relates to the technical field of artificial intelligence, particularly to the technical fields of natural language processing, deep learning, and the like, and specifically to a method of determining similarity between text processing tasks, an apparatus of determining similarity between text processing tasks, an electronic device, a computer-readable storage medium, and a computer program product.

### BACKGROUND

Artificial intelligence is the discipline of the study of making computers simulate certain thinking processes and intelligent behaviors of a human being (such as learning, reasoning, thinking, planning, etc.), and there are both hardware-level and software-level technologies. The artificial intelligence hardware technologies generally include technologies such as sensors, special artificial intelligence chips, cloud computing, distributed storage, large data processing, etc.; The artificial intelligence software technologies mainly include natural language processing technology, computer vision technology, speech recognition technology, machine learning/deep learning, large data processing technology, knowledge graph technology and other major technological directions.

The methods described in this section are not necessarily methods that have been previously conceived or employed. Unless otherwise indicated, it should not be assumed that any method described in this section is considered to be the prior art only due to its inclusion in this section. Similarly, the problems mentioned in this section should not be assumed to be recognized in any prior art unless otherwise indicated.

### SUMMARY

The present disclosure provides a method of determining similarity between text processing tasks, an apparatus of determining similarity between text processing tasks, an electronic device, a computer-readable storage medium, and a computer program product.

According to an aspect of the present disclosure, there is provided a method of determining the similarity between text processing tasks, including: determining a first task, a second task, and a neural network to be trained, the neural network to be trained includes a plurality of network modules and a plurality of importance coefficients corresponding to the plurality of network modules, and each importance coefficient of the plurality of importance coefficients are used to scale a output value of a corresponding network modules; respectively performing a target operation using the first task and the second task as a target task to obtain an embedding feature of the first task and an embedding feature of the second task, where the target operation includes: training the neural network to be trained using text samples corresponding to the target task and obtaining a plurality of trained importance coefficients; and determining an embedding feature of the target task based on the plurality of trained importance coefficients; and determining a task similarity between the first task and the second task based on the embedding feature of the first task and embedding feature of the second task.

According to another aspect of the present disclosure, there is provided an apparatus of determining similarity between text processing tasks, including: a first determination unit configured to determine a first task, a second task, and a neural network to be trained, the neural network to be trained includes a plurality of network modules and a plurality of importance coefficients corresponding to the plurality of network modules, and the plurality of importance coefficients are respectively used to scale output values of the corresponding network modules; an embedding feature obtaining unit configured to respectively use the first task and the second task as the target task to perform a target operation to obtain respective embedding features of the first task and the second task, the embedding feature obtaining unit includes: a training subunit configured to train the neural network to be trained using the text sample corresponding to the target task and obtain a plurality of trained importance coefficients; and a first determination subunit configured to determine an embedding feature of the target task based on the plurality of trained importance coefficients; and a second determination subunit configured to determine the task similarity between the first task and the second task based on the respective embedding features of the first task and the second task.

According to another aspect of the present disclosure, there is provided an electronic device, including: one or more processors; a memory storing one or more programs configured to be executed by the one or more processors, the one or more programs including instructions for: determining a first task, a second task, and a neural network to be trained, the neural network to be trained comprises a plurality of network modules and a plurality of importance coefficients corresponding to the plurality of network modules, and each importance coefficient of the plurality of importance coefficients are used to scale a output value of a corresponding network modules; respectively performing a target operation using the first task and the second task as a target task to obtain an embedding feature of the first task and an embedding feature of the second task, wherein the target operation comprises: training the neural network to be trained using text samples corresponding to the target task and obtain a plurality of trained importance coefficients; and determining an embedding feature of the target task based on the plurality of trained importance coefficients; and determining a task similarity between the first task and the second task based on the embedding feature of the first task and the embedding feature of the second task.

According to another aspect of the present disclosure, there is provided a non-transient computer-readable storage medium storing one or more programs, the one or more programs including instructions, which when executed by one or more processors of an electronic device, cause the electronic device to: determine a first task, a second task, and a neural network to be trained, the neural network to be trained comprises a plurality of network modules and a plurality of importance coefficients corresponding to the plurality of network modules, and each importance coefficient of the plurality of importance coefficients are used to scale a output value of a corresponding network modules; respectively perform a target operation using the first task and the second task as a target task to obtain an embedding feature of the first task and an embedding feature of the second task, wherein the target operation comprises: training the neural network to be trained using text samples corresponding to the target task and obtaining a plurality of trained importance coefficients; and determining an embedding feature of the target task based on the plurality of trained importance coefficients; and determine a task similarity between the first task and the second task based on the embedding feature of the first task and the embedding feature of the second task.

According to another aspect of the present disclosure, there is provided a computer program product, including a computer program, where the computer program implements the method described above when executed by a processor.

According to one or more embodiments of the present disclosure, the present disclosure enables the obtaining of embedding features of different text processing tasks with lower computational cost and storage overhead by setting a plurality of importance coefficients for scaling outputs of a plurality of network modules in a neural network, training the neural network using text samples of the text processing tasks, and then determining embedding features of the text processing tasks based on the trained importance coefficients. In addition, by training the neural network with the same structure using the text samples of the different text processing tasks to obtain the embedding features of the tasks, a more accurate task similarity can be obtained.

It should be understood that the content described in this section is not intended to identify key or important features of the embodiments of the present disclosure, nor is it intended to limit the scope of the present disclosure. Other features of the present disclosure will become readily understood from the following specification.

### BRIEF DESCRIPTION OF THE DRAWINGS

The drawings illustrate embodiments and constitutes a part of the specification and are used in conjunction with the textual description of the specification to explain the example implementations of the embodiments. The illustrated embodiments are for illustrative purposes only and do not limit the scope of the claims. Throughout the drawings, like reference numerals refer to similar but not necessarily identical elements.

FIG. 1 illustrates a schematic diagram of an example system in which various methods described herein may be implemented according to embodiments of the present disclosure;

FIG. 2 illustrates a flowchart of a method of determining similarity between text processing tasks according to an example embodiment of the present disclosure;

FIG. 3 illustrates a flowchart of a method of determining similarity between text processing tasks according to an example embodiment of the present disclosure;

FIG. 4 illustrates a flowchart of training a neural network to be trained according to an example embodiment of the present disclosure;

FIG. 5 illustrates a flowchart of training a neural network to be trained according to an example embodiment of the present disclosure;

FIG. 6 illustrates a structural block diagram of an apparatus of determining similarity between text processing tasks according to an example embodiment of the present disclosure

FIG. 7 illustrates a structural block diagram of an example electronic device that can be used to implement embodiments of the present disclosure.

### DETAILED DESCRIPTION OF THE EMBODIMENTS

The example embodiments of the present disclosure are described below in conjunction with the accompanying drawings, which include various details of the embodiments of the present disclosure to facilitate understanding and should be considered as examples only. Therefore, one of the ordinary skills in the art will recognize that various changes and modifications may be made to the embodiments described herein without departing from the scope of the present disclosure. Similarly, descriptions of well-known functions and structures are omitted in the following description for the purpose of clarity and conciseness.

In the present disclosure, unless otherwise specified, the terms “first”, “second” and the like are used to describe various elements and are not intended to limit the positional relationships, timing relationships, or importance relationships of these elements, and such terms are only used to distinguish one element from another. In some examples, a first element and a second element may refer to the same instance of the element, while in some cases they may also refer to different instances based on the description in the context.

The terms used in the descriptions of the various examples in this disclosure is for the purpose of describing specific examples only and is not intended to be limiting. Unless the context clearly indicates otherwise, if the number of elements is not specifically defined, the element may be one or more. In addition, the term “and/or” used in the present disclosure encompasses any one of the listed items and all the possible combinations thereof.

Text processing tasks (hereinafter referred to simply as tasks) refer to specific work that needs to process and analyze text data. The measure of the similarity between different text processing tasks is enabled by obtaining embedding features of the tasks (the task-specific vector representations).

In the related art, embodiments of obtaining task embeddings of text processing tasks require high computational costs and storage requirements, and the evaluation accuracy of the similarity between different tasks needs to be improved.

To solve the above problem, by setting a plurality of importance coefficients for scaling outputs of a plurality of network modules in a neural network, training the neural network using text samples of text processing tasks, and then determining embedding features of the text processing tasks based on the trained importance coefficients, it is enabled that the embedding features of the different text processing tasks be obtained at a lower computational cost and storage overhead. In addition, by training the neural network with the same structure using the text samples of the different text processing tasks to obtain the embedding features of the tasks, a more accurate task similarity can be obtained.

Embodiments of the present disclosure will be described in detail below with reference to the accompanying drawings.

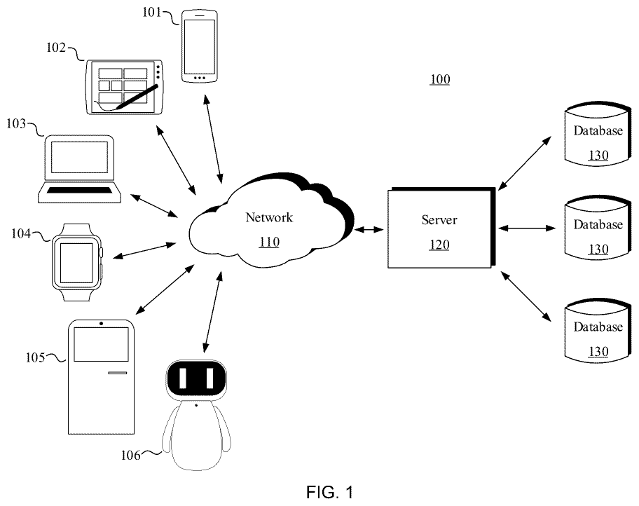

FIG. 1 illustrates a schematic diagram of an example system 100 in which various methods and apparatuses described herein may be implemented in accordance with embodiments of the present disclosure. Referring to FIG. 1, the system 100 includes one or more client devices 101, 102, 103, 104, 105, and 106, a server 120, and one or more communication networks 110 that couple the one or more client devices to the server 120. The client devices 101, 102, 103, 104, 105, and 106 may be configured to execute one or more applications.

In embodiments of the present disclosure, the server 120 may run one or more services or software applications that enable the execution of the method of present disclosure.

In some embodiments, the server 120 may further provide other services or software applications, which may include non-virtual environments and virtual environments. In some embodiments, these services may be provided as web-based services or cloud services, such as to users of the client devices 101, 102, 103, 104, 105, and/or 106 under a Software as a Service (SaaS) model.

In the configuration shown in FIG. 1, the server 120 may include one or more components that implement functions performed by the server 120. These components may include software components, hardware components, or combinations thereof that are executable by one or more processors. A user operating the client devices 101, 102, 103, 104, 105, and/or 106 may sequentially utilize one or more client applications to interact with the server 120 to utilize the services provided by these components. It should be understood that a variety of different system configurations are possible, which may be different from the system 100. Therefore, FIG. 1 is an example of a system for implementing the various methods described herein and is not intended to be limiting.

The user may use the client devices 101, 102, 103, 104, 105, and/or 106 to generate response data using a large model. The client devices may provide interfaces that enable the user of the client devices to interact with the client devices. The client devices may also output information to the user via the interfaces. Although FIG. 1 depicts only six client devices, those skilled in the art will understand that the present disclosure may support any number of client devices.

The client devices 101, 102, 103, 104, 105, and/or 106 may include various types of computer devices, for example, portable handheld devices, general-purpose computers (such as personal computers and laptop computers), workstation computers, wearable devices, smart screen devices, self-service terminal devices, service robots, gaming systems, thin clients, various messaging devices, sensors or other sensing devices, and the like. These computer devices may run various types and versions of software applications and operating systems, such as Microsoft Windows, Apple IOS, Unix-like operating systems, Linux or Linux-like operating systems (e.g., Google Chrome OS); or include various mobile operating systems, such as Microsoft Windows Mobile OS, iOS, Windows Phone, Android. The portable handheld devices may include cellular phones, smart phones, tablet computers, personal digital assistants (PDA), and the like. The wearable devices may include head-mounted displays (such as smart glasses) and other devices. The gaming systems may include various handheld gaming devices, Internet-enabled gaming devices, and the like. The client devices can execute various different applications, such as various Internet related applications, communication applications (e.g., e-mail applications), Short Message Service (SMS) applications, and may use various communication protocols.

The network 110 may be any type of network well known to those skilled in the art, which may support data communication using any of a variety of available protocols (including but not limited to TCP/IP, SNA, IPX, etc.). By way of example only, one or more networks 110 may be a local area network (LAN), an Ethernet-based network, a token ring, a wide area network (WAN), an Internet, a virtual network, a virtual private network (VPN), an intranet, an external network, a blockchain network, a public switched telephone network (PSTN), an infrared network, a wireless network (e.g., Bluetooth, WiFi), and/or any combination of these and/or other networks.

The server 120 may include one or more general-purpose computers, a dedicated server computer (e.g., a PC (personal computer) server, a UNIX server, a mid-end server), a blade server, a mainframe computer, a server cluster, or any other suitable arrangement and/or combination. The server 120 may include one or more virtual machines running a virtual operating system, or other computing architectures involving virtualization (e.g., one or more flexible pools of a logical storage device that may be virtualized to maintain virtual storage devices of a server). In various embodiments, the server 120 may run one or more services or software applications that provide the functions described below.

The computing unit in the server 120 may run one or more operating systems including any of the operating systems described above and any commercially available server operating system. The server 120 may also run any of a variety of additional server applications and/or intermediate layer applications, including a HTTP server, an FTP server, a CGI server, a Java server, a database server, etc.

In some implementations, the server 120 may include one or more applications to analyze and merge data feeds and/or event updates received from the user of the client devices 101, 102, 103, 104, 105, and/or 106. The server 120 may also include one or more applications to display the data feeds and/or the real-time events via one or more display devices of the client devices 101, 102, 103, 104, 105, and/or 106.

In some embodiments, the server 120 may be a server of a distributed system, or a server incorporating a blockchain. The server 120 may also be a cloud server, or an intelligent cloud computing server or an intelligent cloud host with an artificial intelligence technology. The cloud server is a host product in the cloud computing service system used to overcome the defects of high management difficulty and weak service expansibility which exist in the conventional physical host and Virtual Private Server (VPS) service.

The system 100 may also include one or more databases 130. In certain embodiments, these databases may be used to store data and other information. For example, one or more of the databases 130 may be used to store information such as audio files and video files. The databases 130 may reside in various locations. For example, the database used by the server 120 may be local to the server 120, or may be remote from the server 120 and may communicate with the server 120 via a network-based or dedicated connection. The database 130 may be of a different type. In some embodiments, the database used by the server 120 may be, for example, a relational database. One or more of these databases may store, update, and retrieve data to and from the database in response to a command.

In some embodiments, one or more of the databases 130 may also be used by an application to store application data. The database used by the application may be a different type of database, such as a key-value repository, an object repository, or a conventional repository supported by a file system.

The system 100 of FIG. 1 may be configured and operated in various ways to enable application of various methods and devices described according to the present disclosure.

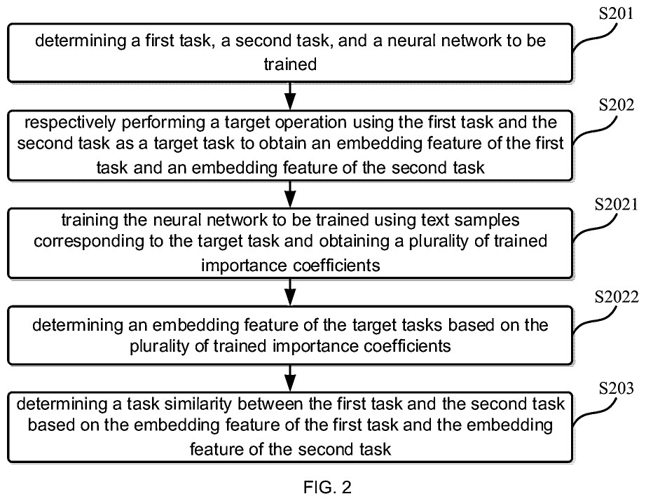

According to an aspect of the present disclosure, there is provided a method of determining similarity between text processing tasks. FIG. 2 illustrates a flowchart of the method of determining similarity between text processing tasks according to an example embodiment of the present disclosure. As illustrated in FIG. 2, the method includes: step S201, determining a first task, a second task, and a neural network to be trained, the neural network to be trained includes a plurality of network modules and a plurality of importance coefficients corresponding to the plurality of network modules, the plurality of importance coefficients are respectively used to scale output values of the corresponding network modules; step S202, respectively using the first task and the second task as a target task to perform a target operation to obtain respective embedding features of the first task and the second task, and the target operation includes: step S2021, training the neural network to be trained using the text sample corresponding to the target task and obtaining a plurality of trained importance coefficients; step S2022, determining an embedding feature of the target tasks based on the plurality of trained importance coefficients; and step S203, determining the task similarity between the first task and the second task based on the respective embedding features of the first task and the second task. It will be understood that steps S2021 and S2022 may be sub-steps of the step S202.

Thereby, by setting the plurality of importance coefficients for scaling the outputs of the plurality of network modules in the neural network, training the neural network using the text sample of the text processing task, and then determining the embedding feature of the text processing task based on the trained importance coefficients, it is enabled that the embedding features of the different text processing tasks can be obtained at a lower computational cost and storage overhead. In addition, by training the neural network with the same structure, using the text samples of the different text processing tasks to obtain the embedding features of the tasks, a more accurate task similarity can be obtained.

As described above, the text processing tasks refer to specific tasks that need to process and analyze textual data, which may include, for example, text classification, sentiment analysis, named entity recognition, summary generation, etc. The above text processing tasks can be represented by task embeddings (task-specific vector representations). The task embeddings of the different tasks can form a semantic space, thus enabling the measure of similarity between the different text processing tasks.

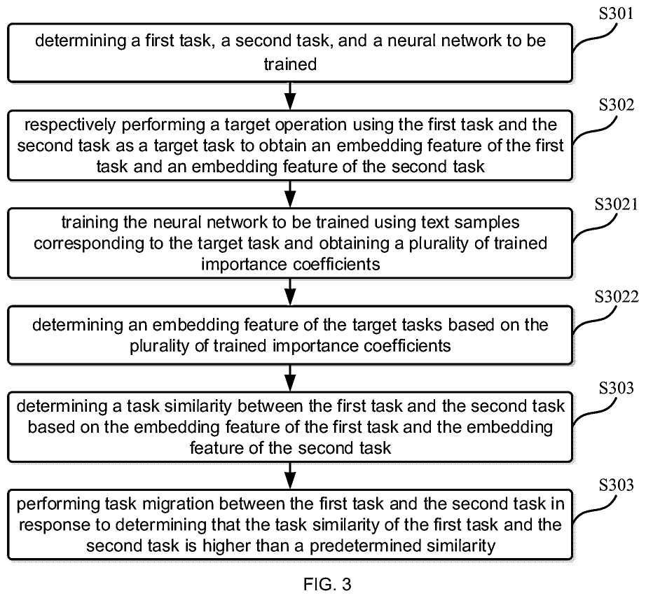

According to some embodiments, after determining the task similarity between the first task and the second task in step S203, the two tasks may be downstream processed based on the task similarity between the two tasks. As shown in FIG. 3, the above method may further include: step S304, performing task migration between the first task and the second task in response to determining that the task similarity between the first task and the second task is higher than a predetermined similarity. It would be understood that the operations and effects of steps S301-S303 and the sub-steps thereof in FIG. 3 may refer to the description of steps S201-S203 and the sub-steps thereof in FIG. 2, which will not be repeated herein.

Task migration means improving the performance of another related task using the knowledge or model of one task. For example, the model and data of an existing news classification task may be used to facilitate a new news classification task, such as to migrate from a sports news classification task to an entertainment news classification task, or an existing movie review sentiment analysis model may be used to improve the effect of product review sentiment analysis. By the above method, it is possible to enable a fast automatic and accurate obtaining of correlations between tasks, thus enabling a highly efficient task migration.

In some embodiments, the task migration may be implemented by data augmentation, i.e., augmenting the training set of the target task (the second task) using the training set of the source task (the first task), especially in the case of less target task data, and the generalization ability of the model may be improved by adding task relevant data.

In some embodiments, the task migration may be implemented by model parameters migration, i.e., migrating some or all of the trained model parameters of the source task (the first task) to the model of the target task (the second task), thereby reducing the training time and resources of the target task.

In some embodiments, the task migration may be implemented by joint training, i.e., training the models of the source task (the first task) and the target task (the second task) at the same time, and the performance of the two tasks can be improved by sharing some of the network structures or parameters.

As can be seen, a reasonable source task can greatly improve the performance of the target task, and similarly, a wrong source task can impair the performance of the target task. Therefore, selection of source tasks is critical to task migration. By using the method of the present disclosure, it is possible to quickly find a large number of source tasks with high similarity for the target task at low computational cost and storage overhead.

In some embodiments, after determining the task similarities of text processing tasks, the following operations may further be performed:

Task clustering: that is, after determining the task similarity between multiple tasks which include the first task and the second task, the multiple tasks can be clustered based on the task similarity between multiple tasks, and thus similar tasks are clustered together. This is very useful for organizing and managing a large number of tasks, especially in multi-task learning or multi-task management scenarios.

Task recommendation: on some platforms (for example, a machine learning model sharing platform), task embeddings may be used to recommend relevant tasks or models. In an example embodiment, based on the embedding feature of the first task that the user is processing, a plurality of other tasks may be used as the second task to determine the task similarity, so as to recommend tasks and models that are similar to the first task, and to facilitate the user to quickly find relevant resources (datasets, models, and the like of similar tasks).

It would be understood that the method of determining the similarity between text processing tasks that is provided by the present disclosure may also be used in richer scenarios, and this is not limited herein.

In step S201, the first task and the second task may be two pre-selected text processing tasks that need to determine the task similarity. The neural network to be trained model may be any neural network model capable of being used to perform text processing.

According to some embodiments, the neural network to be trained is of a Transformer architecture, and the plurality of network modules includes a plurality of self-attention modules and a plurality of feed forward neural network modules.

In the neural network with the Transformer architecture, each layer mainly includes two parts: a Multi-Head Attention module and a Feed Forward Neural Network module. The Multi-Head Attention mechanism can be formalized as:

$$MHA ( x ) = {\sum }_{i = 1}^{{N}_{h}} {Att}_{{W}_{K}^{i} , {W}_{Q}^{i} , {W}_{V}^{i} , {W}_{O}^{i}} ( x )$$

where Att(x) denotes the computation on the input x based on the self-attention mechanism, Nₕ denotes the number of heads of the multi-head, and W_{K}, W_{Q}, W_{V}, W_{O} are the learnable parameters of the self-attention module.

The Feed Forward Neural Network module can be formalized as:

$$FFN ( x ) = GELU ( {XW}_{U} ) \cdot {W}_{D}$$

where GELU(·) is Gaussian Error Linear Units, x is the input to the feed forward neural network, and W_{D} and W_{U} are the learnable parameters of the feed forward neural network.

A learnable importance coefficient m_{H} may be assigned to each self-attention head and a learnable importance coefficient m_{F} may be assigned to each feed forward neural network:

$$MHA ( x ) = {\sum }_{i = 1}^{{N}_{h}} {m}_{H}^{i} {Att}_{{W}_{K}^{i} , {W}_{Q}^{i} , {W}_{V}^{i} , {W}_{O}^{i}} ( x )$$

$$FFN ( x ) = {m}_{F} GELU ( {XW}_{U} ) \cdot {W}_{D}$$

In some embodiments, the neural network to be trained may also employ other network structures, and the plurality of network modules may be other network modules. For example, for fully connected networks, the plurality of network modules may be a plurality of layers or a plurality of neurons.

After learning, the above importance coefficients can scale the output values of the corresponding network modules so as to maintain or upscale the output values of important network modules and to downscale the output values of network modules that have less impact on the output.

In step S202, the first task and the second task may be respectively used as the target task to perform the target operation to obtain the respective embedding features of the first task and the second task. As described above, the target operation may include step S2021 and step S2022.

Prior to performing the step S2021, a training set or dataset corresponding to the target task may be obtained, which may include a plurality of text samples. The text sample may include text data and may include the corresponding ground truth label.

In step S2021, the text data in the text sample may be input into the neural network to be trained, and the text processing result output by the neural network to be trained is obtained. Further, the parameters of the neural network to be trained may be adjusted based on the difference between the text processing result and the ground truth label, including the plurality of learnable parameters in the plurality of network modules and the plurality of importance coefficients. After the training of the neural network to be trained is finished, the plurality of trained importance coefficients may be obtained.

In step S2022, the plurality of trained importance coefficients may be directly determined as the embedding feature of the target task.

According to some embodiments, the neural network to be trained is a large language model. For the large language model, the computational cost and storage cost of obtaining task embeddings using existing approaches are very high, whereas by using the present disclosure, the amount of data that needs to be stored is only the number of multi-head attention modules and the number of feed forward neural networks in the large language model. In some embodiments, the importance coefficients may be Boolean variables (which will be expanded upon below), thereby further reducing the amount of data that need to be stored.

According to some embodiments, the initial values of the plurality of importance coefficients are obtained by random initialization. By training the neural network to be trained using text samples of different tasks, the plurality of importance coefficients obtained by random initialization are enabled to converge to an importance coefficients combination corresponding to different tasks.

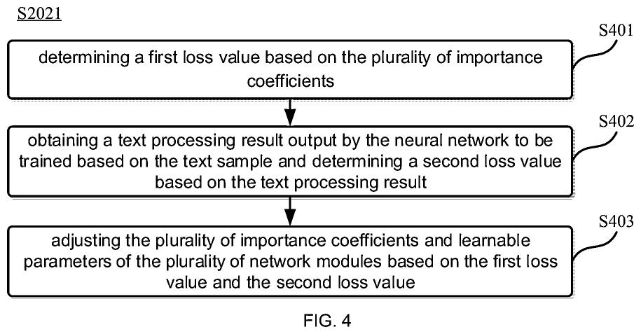

According to some embodiments, as shown in FIG. 4, step S2021, training the neural network to be trained using the text sample corresponding to the target task and obtaining the plurality of trained importance coefficients may include: step S401, determining a first loss value based on the plurality of importance coefficients, where the first loss value is positively correlated with the absolute values of the plurality of importance coefficients; step S402, obtaining the text processing result output by the neural network to be trained based on the text sample, and determining a second loss value based on the text processing result, and the second loss value is used to evaluate the text processing result; and step S403, adjusting the plurality of importance coefficients and the learnable parameters of the plurality of network modules based on the first loss value and the second loss value.

Considering that a neural network is usually sparse, that is, the network modules that play important roles in the neural network are sparse, and therefore the plurality of trained importance coefficients should also be sparse. To ensure the sparsity of the importance coefficients, an additional regularization item may be added to the training objective, that is, the first loss value:

$$ℛ ( 𝓂 ) = {λ}_{H} {‖ {m}_{H} ‖}_{1} + {λ}_{F} {‖ {m}_{F} ‖}_{1}$$

where the λ_{H} and λ_{F} are balance coefficients. The overall training objective of the neural network to be trained may be:

$${min}_{θ , m} ℒ ( θ , m ) + ℛ ( 𝓂 )$$

where the

$${min}_{θ , m} ℒ ( θ , m )$$

denotes the second loss value which is used to evaluate the text processing result.

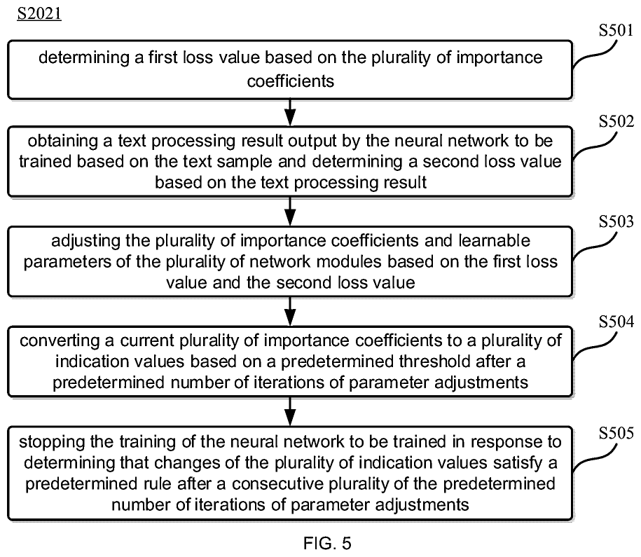

According to some embodiments, as shown in FIG. 5, in step S2021, training the neural network to be trained using the text sample corresponding to the target task and obtaining the plurality of trained importance coefficients may include: step S504, after a predetermined number of iterations of parameter adjustments, converting the current plurality of importance coefficients to a plurality of indication values based on a predetermined threshold; and step S505, stopping the training of the neural network to be trained in response to determining that after a consecutive plurality of the predetermined number of iterations of parameter adjustments the changes of the plurality of indication values satisfy a predetermined rule. It would be understood that the operations of steps S501-S503 in FIG. 5 may refer to the description of steps S401-S403 above, which will not be repeated herein.

In some embodiments, the importance coefficients may be converted into indication values which converge at an early stage (no more than one round, that is, no more than one complete training set traversal). Therefore, an early stopping strategy can be employed such that the model stops at an early training stage according to the above rules. Note, at this point the neural network itself may not converge, that is, the neural network has not yet been able to complete the corresponding target task well, but the indication values obtained by the converting the importance coefficients have converged.

In some cases, the predetermined number of iterations is also referred to as small-epoch or mini-epoch, the value of which may be set as demand, which is not limited herein. In step S505, the training of the neural network to be trained may be stopped in response to determining that after consecutive N number of predetermined number of iterations of parameter adjustments the changes of the plurality of indication values satisfy a predetermined rule. It would be understood that the value of N may be set on demand, which is not limited herein.

In some embodiments, the value of the indication value may be 0 or 1. The importance coefficients that exceed the predetermined threshold may be converted to be 1, and the importance coefficients which do not exceed the predetermined threshold may be converted to be 0.

According to some embodiments, the plurality of indication values are all Boolean variables, and the predetermined rule includes that after a consecutive plurality of the predetermined number of iterations of parameter adjustments, the number of indication values in the plurality of indication values which changes do not exceed a predetermined parameter.

In some embodiments, the training may be stopped in the case that the changes of the masks in several consecutive mini-epoch do not exceed a fixed parameter γ. It would be understood that the value of γ may be set on demand, which is not limited herein.

According to some embodiments, in step S2022, determining the embedding feature of the target task based on the plurality of trained importance coefficients may include: determining the plurality of indication values obtained from the last conversion as the embedding feature of the target task.

In some embodiments, the indication values obtained from the last conversion of the importance coefficients corresponding to the plurality of self-attention mechanism modules and the indication values obtained from the last conversion of the importance coefficients corresponding to the plurality of feed forward neural network modules may be spliced together to obtain the embedding feature of the target task.

According to some embodiments, in step S203, determining the task similarity between the first task and the second task based on the respective embedding features of the first task and the second task may include: determining the task similarity between the first task and the second task based on the number of indication values with the same position and the same value in the embedding feature of the first task and the embedding feature of the second task.

It would be understood that the indication values with the same position indicate that they correspond to the same network module (the self-attention head or the feed-forward neural network), and the values being the same indicates that the network module is important or not important in the first task or the second task. Thus, an accurate task similarity can be easily and quickly obtained through the above way.

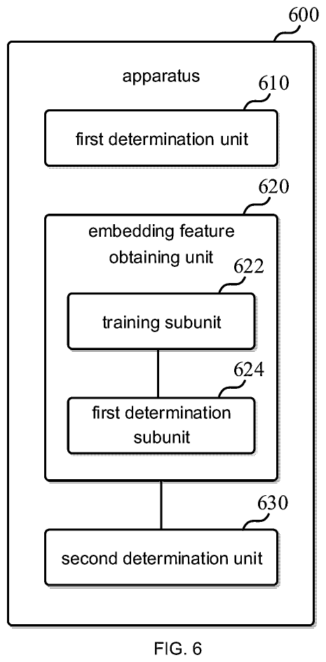

According to another aspect of the present disclosure, there is provided an apparatus of determining similarity between text processing tasks. As shown in FIG. 6, the apparatus 600 includes: a first determination unit 610, configured to determine a first task, a second task, and a neural network to be trained, the neural network to be trained includes a plurality of network modules and a plurality of importance coefficients corresponding to the plurality of network modules, the plurality of importance coefficients are respectively used to scale output values of the corresponding network modules; an embedding feature obtaining unit 620, configured to respectively use the first task and the second task as the target task to perform a target operation to obtain respective embedding features of the first task and the second task, the embedding feature obtaining unit includes: a training subunit 622, configured to train the neural network to be trained using the text sample corresponding to the target task and obtain a plurality of trained importance coefficients; and a first determination subunit 624, configured to determine the embedding feature of the target task based on the plurality of trained importance coefficients; and a second determination unit 630, configured to determine the task similarity between the first task and the second task based on the respective embedding features of the first task and the second task.

It would be understood that the operations and effects of the units 610-630 and the subunits thereof may refer to the description of steps S201-S203 and the sub-steps thereof and will not be repeated herein.

According to some embodiments, the apparatus of determining the similarity between the text processing tasks may further include: a task migration unit, configured to perform task migration between the first task and the second task in response to determining that the task similarity between the first task and the second task is higher than a predetermined similarity.

According to some embodiments, the task migration may include at least one of the following: augmenting the training set of the second task using the training set of the first task; migrating at least a part of the model parameters in the trained neural network for the first task to the neural network for the second task; and simultaneously training the neural network for the first task and the neural network for the second task, where the neural network for the first task and the neural network for the second task share some of the structures or parameters.

According to some embodiments, the neural network to be trained may be a Transformer architecture, and the plurality of network modules may include a plurality of self-attention modules and a plurality of feed forward neural network modules.

According to some embodiments, the neural network to be trained may be a large language model.

According to some embodiments, the initial values of the plurality of importance coefficients may be obtained by random initialization.

According to some embodiments, the training subunit may include: a second determination subunit configured to determine a first loss value based on the plurality of importance coefficients, where the first loss value is positively correlated with the absolute values of the plurality of importance coefficients; an obtaining subunit configured to obtain the text processing result output by the neural network to be trained based on the text sample and determine a second loss value based on the text processing result, and the second loss value is used to evaluate the text processing result; and a parameters adjustment subunit configured to adjust the plurality of importance coefficients and the learnable parameters of the plurality of network modules based on the first loss value and the second loss value.

According to some embodiments, the training subunit may include: a conversion subunit configured to convert the current plurality of importance coefficients to a plurality of indication values based on a predetermined threshold after a predetermined number of iterations of parameter adjustments; and an early stopping subunit configured to stop the training of the neural network to be trained in response to determining that after a consecutive plurality of the predetermined number of iterations of parameter adjustments the changes of the plurality of indication values satisfy a predetermined rule.

According to some embodiments, the plurality of indication values are all Boolean variables, and the predetermined rule includes that after a consecutive plurality of the predetermined number of iterations of parameter adjustments, the number of indication values in the plurality of indication values which changes do not exceed the predetermined parameter.

According to some embodiments, the first determination subunit may include: a third determination subunit configured to determine the plurality of indication values obtained from the last conversion as the embedding feature of the target task.

According to some embodiments, the second determination unit may include: a fourth determination subunit configured to determine the task similarity between the first task and the second task based on the number of indication values with the same position and the same value in the embedding feature of the first task and the embedding feature of the second task.

In the technical solution of the present disclosure, the collection, storage, use, processing, transmission, provision and disclosure of personal information of users involved are in compliance with relevant laws and regulations and do not violate public order and morals.

According to embodiments of the present disclosure, there is provided an electronical device, a readable storage medium and a computer program product.

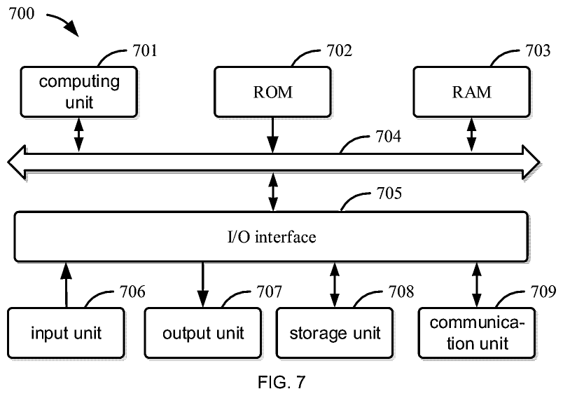

Referring to FIG. 7, a structural block diagram of an electronic device 700 that may be a server or client of the present disclosure is now described, which is an example of a hardware device that may be applied to aspects of the present disclosure. Electronic devices are intended to represent various forms of digital electronic computer devices, such as laptop computers, desktop computers, workstations, personal digital assistants, servers, blade servers, mainframe computers, and other suitable computers. The electronic devices may also represent various forms of mobile devices, such as personal digital processing, cellular telephones, smart phones, wearable devices, and other similar computing devices. The components shown herein, their connections and relationships, and their functions are merely as examples, and are not intended to limit the implementations of the disclosure described and/or claimed herein.

As shown in FIG. 7, the electronic device 700 includes a computing unit 701, which may perform various appropriate actions and processing according to a computer program stored in a read-only memory (ROM) 702 or a computer program loaded into a random access memory (RAM) 703 from a storage unit 708. In the RAM 703, various programs and data required by the operation of the electronic device 700 may also be stored. The computing unit 701, the ROM 702, and the RAM 703 are connected to each other through a bus 704. Input/output (I/O) interface 705 is also connected to the bus 704.

A plurality of components in the electronic device 700 are connected to a I/O interface 705, including: an input unit 706, an output unit 707, a storage unit 708, and a communication unit 709. The input unit 706 may be any type of device capable of inputting information to the electronic device 700, the input unit 706 may receive input digital or character information and generate a key signal input related to user setting and/or function control of the electronic device, and may include, but is not limited to, a mouse, a keyboard, a touch screen, a track pad, a trackball, a joystick, a microphone, and/or a remote control. The output unit 707 may be any type of device capable of presenting information, and may include, but are not limited to, a display, a speaker, a video/audio output terminal, a vibrator, and/or a printer. The storage unit 708 may include, but is not limited to, a magnetic disk and an optical disk. The communication unit 709 allows the electronic device 700 to exchange information/data with other devices over a computer network, such as the Internet, and/or various telecommunication networks, and may include, but is not limited to, a modem, a network card, an infrared communication device, a wireless communication transceiver and/or a chipset, such as a Bluetooth device, a 802.11 device, a WiFi device, a WiMAX device, a cellular communication device, and/or the like.

The computing unit 701 may be a variety of general and/or special purpose processing components with processing and computing capabilities. Some examples of the computing unit 701 include, but are not limited to, a central processing unit (CPU), a graphics processing unit (GPU), various dedicated artificial intelligence (Al) computing chips, various computing units running machine learning model algorithms, a digital signal processor (DSP), and any suitable processor, controller, microcontroller, etc. The computing unit 701 performs the various methods and processes and/or processes described above. For example, in some embodiments, these methods and processes and/or processes may be implemented as a computer software program tangibly contained in a machine-readable medium, such as the storage unit 708. In some embodiments, part or all of the computer programs may be loaded and/or installed onto the electronic device 700 via the ROM 702 and/or the communication unit 709. When the computer program is loaded into the RAM 703 and executed by the computing unit 701, one or more steps of the methods and processes and/or processes described above may be performed. Alternatively, in other embodiments, the computing unit 701 may be configured to perform these methods and processes and/or processes by any other suitable means (e.g., with the aid of firmware).

Various embodiments of the systems and techniques described above herein may be implemented in a digital electronic circuit system, an integrated circuit system, a field programmable gate array (FPGA), an application specific integrated circuit (ASIC), a dedicated standard product (ASSP), a system of system on a chip system (SoC), a complex programmable logic device (CPLD), computer hardware, firmware, software, and/or combinations thereof. These various embodiments may include: implementation in one or more computer programs that may be executed and/or interpreted on a programmable system including at least one programmable processor, where the programmable processor may be a dedicated or universal programmable processor that may receive data and instructions from a storage system, at least one input device, and at least one output device, and transmit data and instructions to the storage system, the at least one input device, and the at least one output device.

The program code for implementing the method of the present disclosure may be written in any combination of one or more programming languages. These program code may be provided to a processor or controller of a general-purpose computer, a special purpose computer, or other programmable data processing device such that the program code, when executed by the processor or controller, causes the functions/operations specified in the flowchart and/or block diagram to be implemented. The program code may be executed entirely on the machine, partly on the machine, partly on the machine as a stand-alone software package and partly on the remote machine or entirely on the remote machine or server.

In the context of the present disclosure, a machine-readable medium may be a tangible medium, which may contain or store a program for use by or in connection with an instruction execution system, device, or device. The machine-readable medium may be a machine-readable signal medium or a machine-readable storage medium. The machine-readable medium may include, but is not limited to, electronic, magnetic, optical, electromagnetic, infrared, or semiconductor systems, apparatus, or devices, or any suitable combination of the foregoing. More specific examples of a machine-readable storage media may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the foregoing.

To provide interaction with a user, the systems and techniques described herein may be implemented on a computer having: a display device (e.g., a CRT (cathode ray tube) or an LCD (liquid crystal display) monitor) for displaying information to a user; and a keyboard and pointing device (e.g., a mouse or trackball) by which a user may provide input to the computer. Other types of devices may also be used to provide interaction with a user; for example, the feedback provided to the user may be any form of perception feedback (e.g., visual feedback, auditory feedback, or tactile feedback); and the input from the user may be received in any form (including acoustic input, voice input, or haptic input).

The systems and techniques described herein may be implemented in a computing system including a back-end component (e.g., as a data server), or a computing system including a middleware component (e.g., an application server), or a computing system including a front-end component (e.g., a user computer with a graphical user interface or a web browser, the user may interact with implementations of the systems and techniques described herein through the graphical user interface or the web browser), or in a computing system including any combination of such back-end components, middleware components, or front-end components. The components of the system may be interconnected by digital data communication (e.g., a communications network) in any form or medium. Examples of communication networks include a local area network (LAN), a wide area network (WAN), the Internet, and a blockchain network.

The computer system may include a client and a server. Clients and servers are generally remote from each other and typically interact through a communication network. The relationship between clients and servers is generated by computer programs running on respective computers and having a client-server relationship to each other. The server may be a cloud server, or may be a server of a distributed system, or a server incorporating a blockchain.

It should be understood that the various forms of processes shown above may be used, and the steps may be reordered, added, or deleted. For example, the steps described in the present disclosure may be performed in parallel or sequentially or in a different order, as long as the results expected by the technical solutions disclosed in the present disclosure can be achieved, and no limitation is made herein.

Although embodiments or examples of the present disclosure have been described with reference to the accompanying drawings, it should be understood that the foregoing methods, systems, and devices are merely embodiments or examples, and the scope of the present disclosure is not limited by these embodiments or examples, but is only defined by the authorized claims and their equivalents. Various elements in the embodiments or examples may be omitted or may be replaced by equivalent elements thereof. Further, the steps may be performed by a different order than described in this disclosure. Further, various elements in the embodiments or examples may be combined in various ways. Importantly, with the evolution of technologies, many elements described herein may be replaced by equivalent elements appearing after the present disclosure.

1. A method of determining similarity between text processing tasks, comprising:
determining a first task, a second task, and a neural network to be trained, the neural network to be trained comprises a plurality of network modules and a plurality of importance coefficients corresponding to the plurality of network modules, and each importance coefficient of the plurality of importance coefficients are used to scale a output value of a corresponding network modules;
respectively performing a target operation using the first task and the second task as a target task to obtain an embedding feature of the first task and an embedding feature of the second task, wherein the target operation comprises:
training the neural network to be trained using text samples corresponding to the target task and obtaining a plurality of trained importance coefficients; and
determining an embedding feature of the target task based on the plurality of trained importance coefficients; and
determining a task similarity between the first task and the second task based on the embedding feature of the first task and the embedding feature of the second task.

2. The method of claim 1, wherein training the neural network to be trained using the text samples corresponding to the target task and obtaining the plurality of trained importance coefficients comprises:
determining a first loss value based on the plurality of importance coefficients, wherein the first loss value is positively correlated with absolute values of the plurality of importance coefficients;
obtaining a text processing result output by the neural network to be trained based on the text sample and determining a second loss value based on the text processing result, wherein the second loss value is used to evaluate the text processing result; and
adjusting the plurality of importance coefficients and learnable parameters of the plurality of network modules based on the first loss value and the second loss value.

3. The method of claim 2, wherein training the neural network to be trained using the text samples corresponding to the target task and obtaining the plurality of trained importance coefficients comprises:
converting a current plurality of importance coefficients to a plurality of indication values based on a predetermined threshold after a predetermined number of iterations of parameter adjustments; and
stopping the training of the neural network to be trained in response to determining that changes of the plurality of indication values satisfy a predetermined rule after a consecutive plurality of the predetermined number of iterations of parameter adjustments.

4. The method of claim 3, wherein the plurality of indication values are all Boolean variables, and the predetermined rule includes that after a consecutive plurality of the predetermined number of iterations of parameter adjustments, a number of indication values in the plurality of indication values which changes does not exceed a predetermined parameter.

5. The method of claim 3, wherein determining the embedding feature of the target task based on the plurality of trained importance coefficients comprises:
determining a plurality of indication values obtained from a last conversion as the embedding feature of the target task.

6. The method of claim 5, wherein determining a task similarity between the first task and the second task based on the embedding feature of the first task and the embedding feature of the second task comprises:
determining the task similarity between the first task and the second task based on a number of indication values with a same position and a same value in the embedding feature of the first task and the embedding feature of the second task.

7. The method of claim 1, wherein the neural network to be trained is of a Transformer architecture, and the plurality of network modules includes a plurality of self-attention modules and a plurality of feed forward neural network modules.

8. The method of claim 7, wherein the neural network to be trained is a large language model.

9. The method of claim 1, wherein initial values of the plurality of importance coefficients are obtained by random initialization.

10. The method of claims 1, further comprising:
performing task migration between the first task and the second task in response to determining that the task similarity between the first task and the second task is higher than a predetermined similarity.

11. The method of claim 10, wherein, the task migration includes at least one of the following:
augmenting a training set of the second task using a training set of the first task;
migrating at least a part of the model parameters in a trained neural network for the first task to a neural network for the second task; and
simultaneously training a neural network for the first task and a neural network for the second task, wherein the neural network for the first task and the neural network for the second task share a portion of the structures or parameters.

12. An electronic device, comprising:
one or more processors;
a memory storing one or more programs configured to be executed by the one or more processors, the one or more programs including instructions for:
determining a first task, a second task, and a neural network to be trained, the neural network to be trained comprises a plurality of network modules and a plurality of importance coefficients corresponding to the plurality of network modules, and each importance coefficient of the plurality of importance coefficients are used to scale a output value of a corresponding network modules;
respectively performing a target operation using the first task and the second task as a target task to obtain an embedding feature of the first task and an embedding feature of the second task, wherein the target operation comprises:
training the neural network to be trained using text samples corresponding to the target task and obtain a plurality of trained importance coefficients; and
determining an embedding feature of the target task based on the plurality of trained importance coefficients; and
determining a task similarity between the first task and the second task based on the embedding feature of the first task and the embedding feature of the second task.

13. The electronic device of claim 12, wherein training the neural network to be trained using the text samples corresponding to the target task and obtaining the plurality of trained importance coefficients comprises:
determining a first loss value based on the plurality of importance coefficients, wherein the first loss value is positively correlated with absolute values of the plurality of importance coefficients;
obtaining a text processing result output by the neural network to be trained based on the text sample and determining a second loss value based on the text processing result, wherein the second loss value is used to evaluate the text processing result; and
adjusting the plurality of importance coefficients and learnable parameters of the plurality of network modules based on the first loss value and the second loss value.

14. The electronic device of claim 13, wherein training the neural network to be trained using the text samples corresponding to the target task and obtaining the plurality of trained importance coefficients comprises:
converting a current plurality of importance coefficients to a plurality of indication values based on a predetermined threshold after a predetermined number of iterations of parameter adjustments; and
stopping the training of the neural network to be trained in response to determining that changes of the plurality of indication values satisfy a predetermined rule after a consecutive plurality of the predetermined number of iterations of parameter adjustments.

15. The electronic device of claim 14, wherein the plurality of indication values are all Boolean variables, and the predetermined rule includes that after a consecutive plurality of the predetermined number of iterations of parameter adjustments, a number of indication values in the plurality of indication values which changes does not exceed the predetermined parameter.

16. The electronic device of claim 14, wherein determining the embedding feature of the target task based on the plurality of trained importance coefficients comprises:
determining a plurality of indication values obtained from a last conversion as the embedding feature of the target task.

17. The electronic device of claim 16, wherein determining a task similarity between the first task and the second task based on the embedding feature of the first task and the embedding feature of the second task comprises:
determining the task similarity between the first task and the second task based on a number of indication values with a same position and a same value in the embedding feature of the first task and the embedding feature of the second task.

18. The electronic device of claims 12, wherein the one or more programs further including instructions for:
a task migration unit, configured to perform task migration between the first task and the second task in response to determining that the task similarity between the first task and the second task is higher than a predetermined similarity.

19. The electronic device of claim 18, wherein, the task migration includes at least one of the following:
augmenting a training set of the second task using a training set of the first task;
migrating at least a part of the model parameters in a trained neural network for the first task to a neural network for the second task; and
simultaneously training a neural network for the first task and a neural network for the second task, wherein the neural network for the first task and the neural network for the second task share a portion of the structures or parameters.

20. A non-transient computer-readable storage medium storing one or more programs, the one or more programs comprising instructions, which when executed by one or more processors of an electronic device, cause the electronic device to:
determine a first task, a second task, and a neural network to be trained, the neural network to be trained comprises a plurality of network modules and a plurality of importance coefficients corresponding to the plurality of network modules, and each importance coefficient of the plurality of importance coefficients are used to scale a output value of a corresponding network modules;
respectively perform a target operation using the first task and the second task as a target task to obtain an embedding feature of the first task and an embedding feature of the second task, wherein the target operation comprises:
training the neural network to be trained using text samples corresponding to the target task and obtaining a plurality of trained importance coefficients; and
determining an embedding feature of the target task based on the plurality of trained importance coefficients; and
determine a task similarity between the first task and the second task based on the embedding feature of the first task and the embedding feature of the second task.
